(19) United States
(12) Patent Application Publication
(10) Pub. No.: US 2008/0021857 A1
(43) Pub. Date: Jan. 24, 2008

(54) Electronic Data Storing Apparatus

(75) Inventors: Shinji Makishima, Tokyo (JP); Kazuhiro Ogura, Fujisawa-shi (JP); Akihiro Mizutani, Tokyo (JP); Toshihiro Ida, Tokyo (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/456,560

(22) Filed: Jul. 10, 2006

(51) Int. Cl. G06F 17/30

(52) U.S. Cl. 707/1

(57) ABSTRACT

An electronic data storing apparatus includes a data acquiring unit configured to acquire plural electronic data, a data displaying unit configured to display plural electronic data acquired by the data acquiring unit, a signing unit configured to apply, when an instruction for applying a digital signature to plural electronic data displayed by the data displaying unit is acquired, the digital signature to each of the plural electronic data, and a data transmitting unit configured to transmit the plural electronic data and signature data applied to each of the plural electronic data by the signing unit to a transmission destination set.

### BACKGROUND OF THE INVENTION

1. Field of the Invention

The present invention relates to an electronic data storing apparatus that stores managed paper documents as electronic data.

2. Description of the Related Art

Paper documents managed in companies and the like tend to be stored in an electronic form and managed. When the paper documents are managed as electronic data in this way, in general, the paper documents are scanned by a scanner and electronic data, which is an image file created, is stored. In this case, it is necessary to guarantee readability, integrity, and the like of the electronic image file. Thus, it is necessary to perform designation of resolution, visual confirmation of content of the file, and the like to guarantee readability. Further, it is necessary to apply a digital signature and a time stamp to guarantee integrity.

When the image file is managed as described above, there may be plural image files. A technique for collectively applying, even when there are plural image files in this way, a digital signature to the image files is known. For example, P2002-132759 describes a technique for adding authentication information to document data to be approved and generating document data after approval, displaying data for collective approval obtained by combining plural document data added with the authentication information, and, then, adding authentication information for the entire data for collective approval.

However, the technique described above is a technique for applying a digital signature to an image obtained by combining plural image files (electronic data). Thus, it is impossible to collectively apply a digital signature to the plural image files (electronic data).

### BRIEF SUMMARY OF THE INVENTION

It is an object of the invention to provide an electronic data storing apparatus that can collectively apply a digital signature to plural electronic data.

According to an aspect of the invention, an electronic data storing apparatus includes: a data acquiring unit configured to acquire plural electronic data; a data displaying unit configured to display plural electronic data acquired by the data acquiring unit; a signing unit configured to apply, when an instruction for applying a digital signature to plural electronic data displayed by the data displaying unit is acquired, the digital signature to each of the plural electronic data; and a data transmitting unit configured to transmit the plural electronic data and signature data applied to each of the plural electronic data by the signing unit to a transmission destination set.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention

FIG. 1 is a diagram schematically showing a network structure in a first embodiment of the invention;

FIG. 2 is a block diagram showing a main structure of a PC in the embodiment;

FIG. 3 is a flowchart showing a main part of processing at the time when the PC applies processing to image data in the embodiment;

FIG. 4 is a diagram showing an example of a display screen at the time when plural electronic data acquired is displayed in the embodiment;

FIG. 5 is a block diagram showing a main structure of a PC in a second embodiment;

FIG. 6 is a table in which a result of judgment by a content confirmation judging unit is recorded in the embodiment;

FIG. 7 is a flowchart showing a main part of processing at the time when the PC applies processing to image data in the embodiment;

FIG. 8 is a diagram for explaining scroll bars displayed on a display screen in the embodiment;

FIG. 9 is a diagram for explaining a specific portion displayed on the display screen in the embodiment;

FIG. 10 is a diagram for explaining a confirmation button displayed on the display screen in the embodiment;

FIG. 11 is a diagram showing an example of a display screen for a table of electronic data not signed in the embodiment;

FIG. 12 is a block diagram showing a main structure of a PC in a third embodiment;

FIG. 13 is a flowchart showing a main part of processing at the time when the PC applies processing to image data in the embodiment; and

FIG. 14 is a diagram showing an example of a display screen at the time when electronic data not signed is displayed in the embodiment.

### DETAILED DESCRIPTION OF THE INVENTION

Embodiments of the invention will be hereinafter explained with reference to the drawings.

### First Embodiment

First, a first embodiment will be explained.

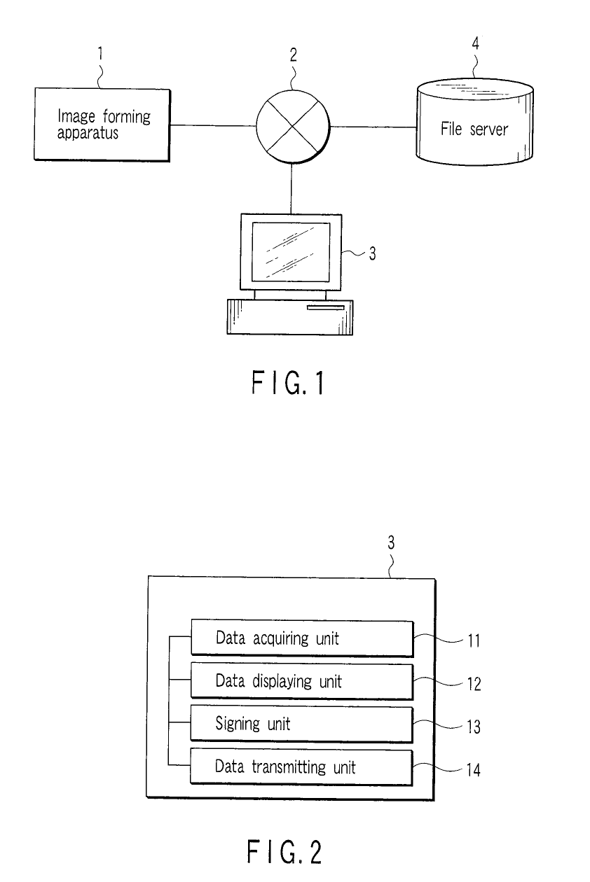

FIG. 1 is a diagram schematically showing a network structure. As shown in FIG. 1, an image forming apparatus 1 is connected to a communication network 2. A personal computer (PC) serving as a data storing apparatus and a file server 4 are further connected to this communication network 2. The image forming apparatus 1 is, for example, a copying machine having a network scanner function. Electronic data indicating an image read from a paper document by the network scanner function of this image forming apparatus 1 is stored in the PC 3 via the communication network 2. After processing for applying a digital signature (details of the processing will be described later) is applied to the image data by the PC 3, an image file subjected to the processing is stored in the file server 4.

FIG. 2 is a block diagram showing a main structure of the PC 3 in the first embodiment. As shown in FIG. 2, the PC 3 has a data acquiring unit 11, a data displaying unit 12, a signing unit 13, and a data transmitting unit 14. The data acquiring unit 11 acquires information (file names, directory paths, etc.) of plural electronic data stored in a hard disk or the like in the PC 3. The data displaying unit 12 displays, on a display of the PC 3, a form screen for displaying a list and content of electronic data. The signing unit 13 applies a digital signature to the electronic data and creates signature data. The data transmitting unit 14 transmits the electronic data signed and the signature data to a specific directory of the hard disk or the like, the file server 4, and the like. In this embodiment, it is assumed that the data are transmitted to the file server 4. Functions of the data acquiring unit 11, the data displaying unit 12, the signing unit 13, and the data transmitting unit 14 are realized by a CPU, a ROM, a RAM, and the like in the PC 3.

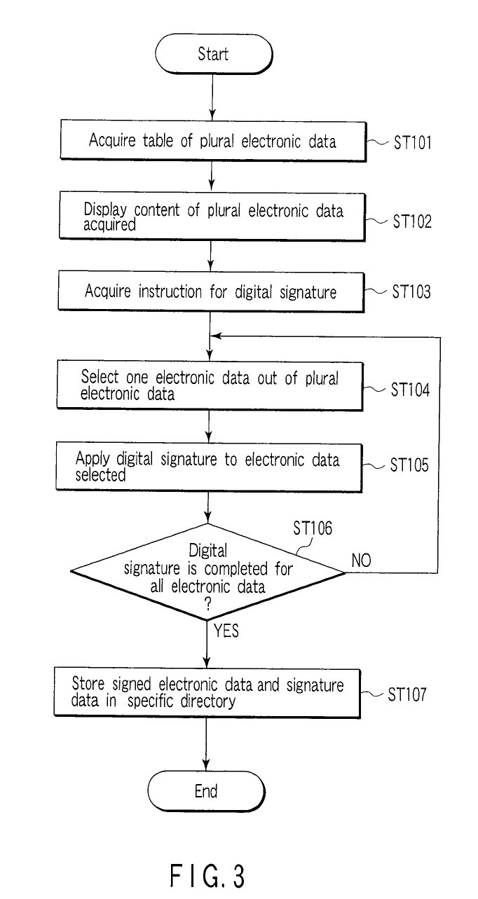

FIG. 3 is a flowchart showing a main part of processing at the time when the PC 3 applies processing to image data. When an instruction to acquire a table of plural electronic data (plural image files) is inputted by a user via an input unit of the PC 3, a table of plural electronic data is acquired by the data acquiring unit 11 (ST101). In other words, a table of information of plural electronic data stored in a specific directory is acquired.

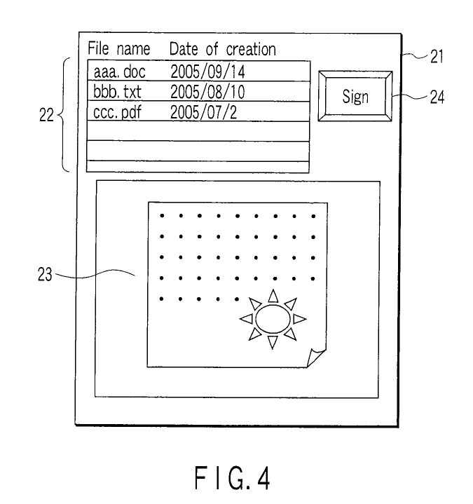

Subsequently, content of the plural electronic data acquired is displayed on the PC 3 by the data displaying unit 12 (ST102). FIG. 4 is a diagram showing a display screen 21 at the time when the plural electronic data acquired are displayed thereon. On the display screen 21 shown in FIG. 4, a section 22 in which a table of information (file names, etc.) of the plural electronic data is displayed in a list format, a section 23 in which electronic data of a list selected out of lists displayed in the list format is displayed, and a button 24 for receiving an instruction for applying a digital signature to the electronic data listed in the list from the user are displayed.

The PC 3 receives an input of the button 24 from the user and acquires the instruction for a digital signature (ST103), one list is selected out of the lists, or one electronic data is selected out of the plural electronic data acquired (ST104), and the digital signature is applied to the electronic data selected (ST105). It is judged whether the digital signature has been completed for all the electronic data (ST106). When a judgment result is NO in step ST106, the PC 3 returns to step ST104 and the processing from step ST104 to step ST106 is repeated until the judgment result in ST106 changes to YES. The processing from step ST103 to step ST106 is performed by the signing unit 13. Therefore, even if the digital signature is applied to the plural electronic data at a time, the digital signature is applied to each of the electronic data.

When a judgment result is YES in step ST106, the electronic data acquired, that is, the electronic data signed and signature data corresponding to the respective electronic data are stored in a specific directory of the file server 4 (ST107).

According to this embodiment, when plural electronic data are collectively signed, it is possible to apply a digital signature to each of the plural electronic data. Therefore, it is possible to improve convenience of the digital signature.

### Second Embodiment

A second embodiment will be described. Components identical with those in the first embodiment are denoted by the identical reference numerals and signs and detailed explanations of the components are omitted.

In collectively signing plural electronic data, it is unknown whether it has been confirmed by a user that content of the electronic data is correct. Therefore, the PC 3 judges whether content of the electronic data has been correctly confirmed by the user and records information indicating a result of the judgment. The PC 3 that applies a digital signature only to electronic data, content of which has been confirmed as correct, among the plural electronic data will be hereinafter explained.

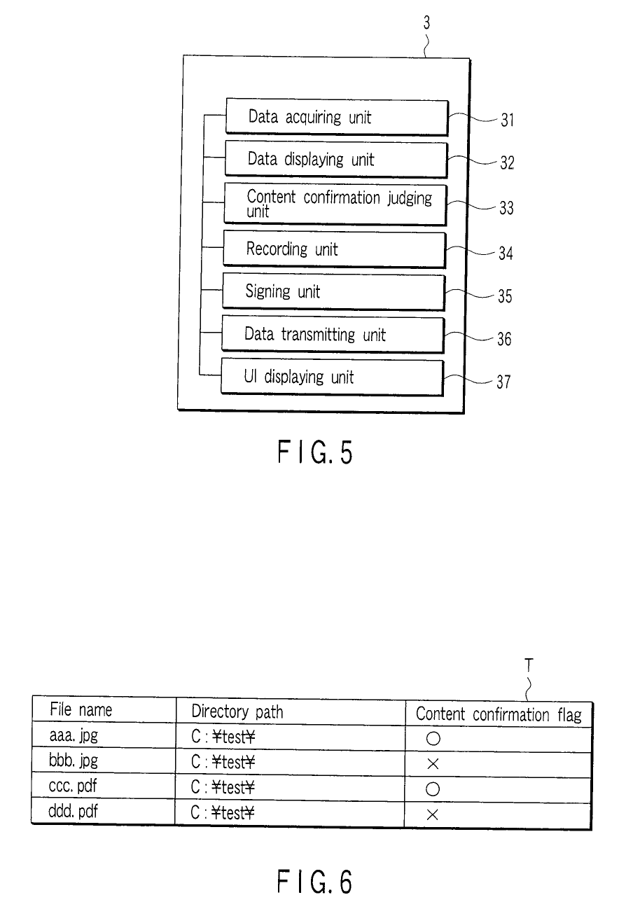

FIG. 5 is a block diagram showing a main structure of the PC 3 in the second embodiment. As shown in FIG. 5, the PC 3 has a data acquiring unit 31, a data displaying unit 32, a content confirmation judging unit 33, a recording unit 34, a signing unit 35, a data transmitting unit 36, and a user interface (UI) displaying unit 37. Since the data acquiring unit 31, the data displaying unit 32, and the data transmitting unit 36 are the same as the data acquiring unit 11, the data displaying unit 12, and the data transmitting unit 14 in the first embodiment, explanations of the units are omitted.

The content confirmation judging unit 33 judges, in accordance with a condition set, whether content of electronic data displayed on the data displaying unit 32 has been accurately confirmed by the user. This condition set will be described later. The recording unit 34 records a result of the judgment by the content confirmation judging unit 33. The signing unit 35 applies, on the basis of the judgment result of the content confirmation judging unit 33 recorded in the recording unit 34, a digital signature only to electronic data, content of which has been correctly confirmed, among the plural electronic data acquired. The UI displaying unit 37 displays electronic data, which have not been correctly confirmed, among the plural electronic data acquired on the PC 3.

FIG. 6 is a table T in which a result of judgment by the content confirmation judging unit 33 is recorded. In the table T, in addition to areas in which file names and directory paths corresponding to plural electronic data acquired by the data acquiring unit 31 are recorded, an area of a content confirmation flag indicating a result of judgment by the content confirmation judging unit 33 is provided. As the content confirmation flag, in this embodiment, “A” is recorded when content of electronic data has been correctly confirmed by the user and “B” is recorded when the content has not beer) correctly confirmed by the user.

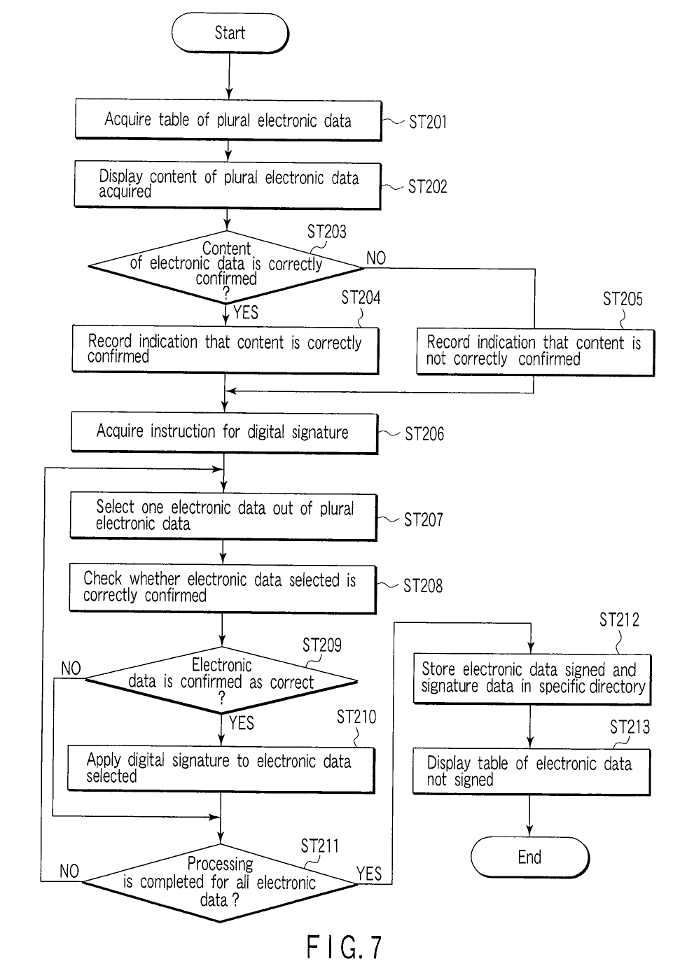

FIG. 7 is a flowchart showing a main part of processing at the time when the PC 3 applies processing to image data. Processing in steps ST201 and ST202 is the same as the processing in steps ST101 and ST102.

It is judged by the content confirmation judging unit 33 whether content of electronic data has been correctly confirmed in accordance with a condition set in advance (ST203). In this second embodiment, any one of the following eight conditions is set in advance for data displayed in the section 23 shown in FIG. 4 in which electronic data is displayed.

A first condition for judging that electronic data has been correctly confirmed is whether the electronic data is displayed in the section 23 in which the electronic data is displayed. When the electronic data is displayed in the section 23, it is judged that the electronic data has been correctly confirmed. When the electronic data is not displayed in the section 23, it is judged that the electronic data has not been correctly confirmed.

A second condition for judging that electronic data has been correctly confirmed is whether all pixels (i.e., all data) of the electronic data are displayed in the section 23 in which the electronic data is displayed. It is possible to acquire all the pixels (the number of pixels in a square) of the electronic data from a file. It is possible to distinguish, in terms of a program, a place displayed and a place not displayed of all the pixels of the file by acquiring coordinates of a position of a portion displayed in a portion to be displayed in the electronic data (the left end of the file is set as (0, 0)). Therefore, it is possible to judge whether the user has displayed all the pixels of the electronic data. In other words, when all the pixels of the electronic data are displayed in the section 23, it is judged that the electronic data has been correctly confirmed and, when all the pixels of the electronic data are not displayed in the section 23, it is judged that the electronic data has not been correctly confirmed.

A third condition for judging that the electronic has been correctly confirmed is whether the number of pixels set in advance of all the pixels (80% of the entire number of pixels) of the electronic data has been displayed. This is because it is not always necessary to confirm all data of the electronic data to be displayed. In other words, when some percentage set of all the pixels of the electronic data is displayed in the section 23, it is judged that the electronic data has been correctly confirmed and, when some percentage of all the pixels of the electronic data is not displayed in the section 23, it is judged that the electronic data has not been correctly confirmed. In general, in the case of a document, upper, lower, left, and right ends are blanks and include no information. Therefore, a condition that pixels equivalent to some percentage from the center of all the pixels are displayed may be adopted.

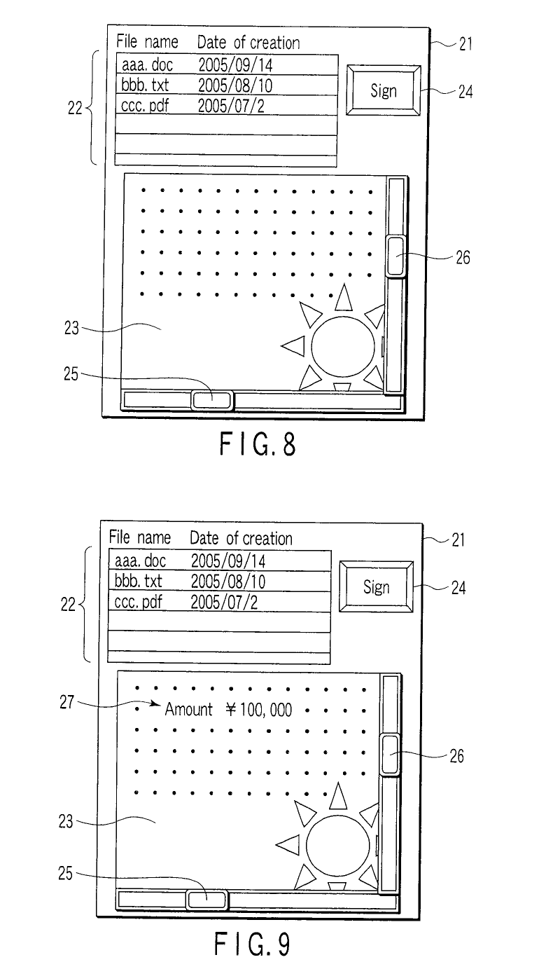

A fourth condition for judging that the electronic data has been correctly confirmed is whether, when the electronic data is displayed in the section 23 in which the electronic data is displayed, scroll bars displayed near the electronic data has been entirely scrolled. FIG. 8 is a diagram for explaining the scroll bars displayed in the section 23. As shown in FIG. 8, scroll bars 25 and 26 are displayed in the vertical direction and the horizontal direction in association with a size of the electronic data. Therefore, when the scroll bars 25 and 26 in the vertical direction and the horizontal direction are entirely scrolled, it is judged that the electronic data has been correctly confirmed and, when the scroll bars 25 and 26 in the vertical direction and the horizontal direction are not entirely scrolled, it is judged that the electronic data has not been correctly confirmed.

A fifth condition for judging that the electronic data has been correctly confirmed is whether the electronic data is displayed for a predetermined time (e.g., three seconds) or more in the section 23 in which the electronic data is displayed. This is because, even if the electronic data is displayed in the section 23, the user has not properly confirmed content displayed in some cases. Therefore, when the electronic data is displayed for the predetermined time or more in the section 23, it is judged that the electronic data has been correctly confirmed and, when the electronic data is not displayed for the predetermined time or more in the section 23, it is judged that the electronic data has not been correctly confirmed.

A sixth condition for judging whether the electronic data has been correctly confirmed is whether a specific portion set in advance of the electronic data is displayed in the section 23 in which the electronic data is displayed. This is because, for example, depending on a document, only a certain portion of the document is important and the user only has to confirm the portion. As shown in FIG. 9, when the electronic data is an image file of a receipt, the user only has to be capable of confirming a portion 27 in which an amount is written as a specific portion. Therefore, when the specific portion 27 of the electronic data is displayed in the section 23, it is judged that the electronic data has been correctly confirmed and, when the specific portion 27 of the electronic data is not displayed in the section 23, it is judged that the electronic data has not been correctly confirmed. A technology for extracting a specific portion from electronic data (an image file) is a publicly-known technique. By managing information on positional coordinates of the portion as attribute information of the electronic data, it is possible to judge whether a specific place of the electronic data is displayed in the portion. The specific portion set in advance may be different depending on a document. For example, in the case of a receipt, it is necessary to confirm a portion where a total amount is displayed. In the case of an agreement, it is necessary to confirm all portions of the electronic data. Therefore, the user may register content of a document by inputting the content in advance and change a specific portion set in advance according to the content of the document.

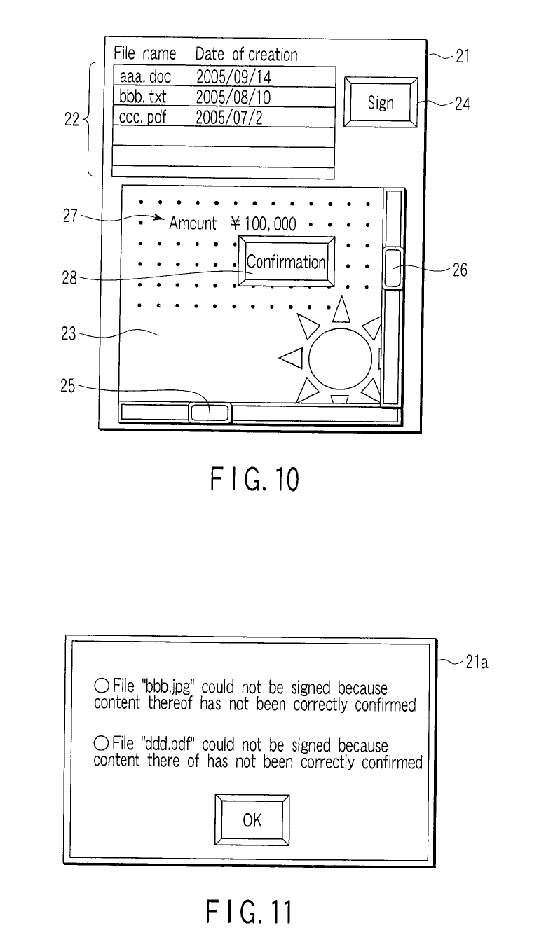

A seventh condition for judging whether the electronic data has been correctly confirmed is whether, as shown in FIG. 10, a confirmation button 28 serving as an indication of confirmation by the user is inputted near the specific portion set in advance of the electronic data explained in the sixth condition. Therefore, when the confirmation button 28 is inputted, it is judged that the electronic data has been correctly confirmed and, when the confirmation button 28 is not inputted, it is judged that the electronic data has not been correctly confirmed.

An eighth condition for judging that the electronic data has been correctly confirmed is whether, assuming that the confirmation button 28 explained in the seventh condition is displayed in a translucent or transparent color, the confirmation button 28 displayed in the translucent or transparent color is inputted. This is because, when the confirmation button 28 is displayed, it is impossible to display data behind the confirmation button 28. Therefore, when the confirmation button 28 is inputted, it is judged that the electronic data has been correctly confirmed and, when the confirmation button 28 is not inputted, it is judged that the electronic data has not been correctly confirmed.

In accordance with a condition set in advance among the conditions described above, it is judged on the basis of all the electronic data acquired whether the electronic data has been correctly confirmed.

For the electronic data judged as having been correctly confirmed, the PC 3 records, using the recording unit 34, “A” in an area of the content confirmation flag corresponding to the electronic data of the table T explained with reference to FIG. 6 (ST204). For the electronic data not correctly confirmed, the PC 3 records “B” in an area of the content confirmation flag corresponding to the electronic data of the table (ST205).

When the PC 3 receives an input of the button 24 from the user and acquires an instruction for a digital signature (ST206), one of the lists is selected, or one electronic data is selected out of the plural electronic data acquired (ST207). The PC 3 checks whether the electronic data selected has been correctly confirmed (ST208). This check is performed with reference to the table T explained with reference to FIG. 6. Subsequently, it is judged whether the electronic data has been confirmed as correct (ST209). When the electronic data selected is confirmed as correct (YES in ST209), a digital signature is applied to the electronic data selected (ST210). If the electronic data selected is not confirmed as correct (NO in ST209), a digital signature is not applied to the electronic data. It is judged whether the processing has been completed for all the electronic data (ST211). When a judgment result is NO in step ST211, the PC 3 returns to step ST207. The processing from step ST207 to step ST211 is repeated until the judgment result changes to YES in step ST211. This processing from step ST206 to step ST211 is performed by the signing unit 35. Therefore, in applying a digital signature to the plural electronic data at one time, the digital signature is applied to each of the electronic data confirmed as correct.

When the judgment result is YES in step ST211, the electronic data signed and signature data corresponding to the respective electronic data are stored in a specific directory of the file server 4 (ST212). A table of the electronic data not signed is displayed on the PC 3 by the UI displaying unit 37. FIG. 11 is a diagram showing a display screen 21a of the table of the electronic data not signed.

According to this second embodiment, in collectively applying a digital signature to plural electronic data, the digital signature is applied to the electronic data correctly confirmed, respectively. However, the digital signature is not applied to the electronic data not correctly confirmed. Therefore, it is possible to prevent the digital signature from being applied to electronic data, content of which has not been confirmed, by mistake.

In confirming content of electronic data, it is a general practice for the user to cause the PC 3 to display the electronic data using application software such as a viewer available on the market and confirm the content of the electronic data by visually observing the electronic data. However, this does not make it possible to judge on a system side whether the content of the electronic data has been correctly confirmed. According to this second embodiment, in accordance with a condition set among the eight conditions set in advance, it is recorded in the table T whether electronic data has been correctly confirmed and it is judged, on the basis of the content recorded in the table T, whether the electronic data has been correctly confirmed. Therefore, it is possible to judge in terms of a system that the user has correctly confirmed the content

### Third Embodiment

A third embodiment will be described. Components identical with those in the first embodiment are denoted by the identical reference numerals and signs and detailed explanations of the components are omitted.

In this third embodiment, in applying a digital signature to electronic data, content of which has been confirmed by a user, an image quality of the electronic data is checked and the digital signature is applied to electronic data with a low image quality after asking the user whether the digital signature may be applied to the electronic data.

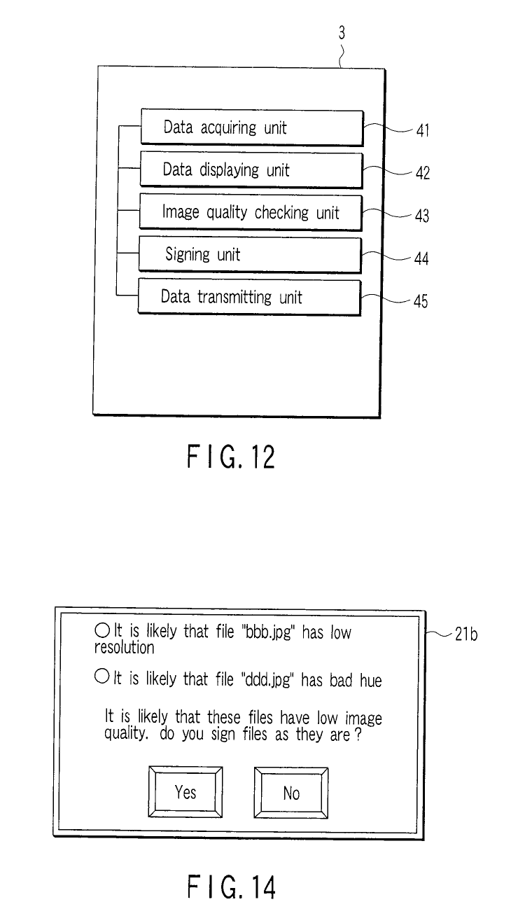

FIG. 12 is a block diagram showing a main structure of the PC 3 in the third embodiment. As shown in FIG. 12, the PC 3 has a data acquiring unit 41, a data displaying unit 42, an image quality checking unit 43, a signing unit 44, and a data transmitting unit 45. Since the data acquiring unit 41, the data displaying unit 42, and the data transmitting unit 45 are the same as the data acquiring unit 11, the data displaying unit 12, and the data transmitting unit 14 in the first embodiment, explanations of the units are omitted.

The image quality checking unit 43 checks an image quality of electronic data to be signed. The signing unit 44 applies a digital signature to electronic data that has a satisfactory image quality and applies the digital signature to electronic data that does not have a satisfactory image quality after asking the user whether the digital signature may be applied. The digital signature is not applied to electronic data that does not have a satisfactory image quality and for which confirmation of the user has not been obtained.

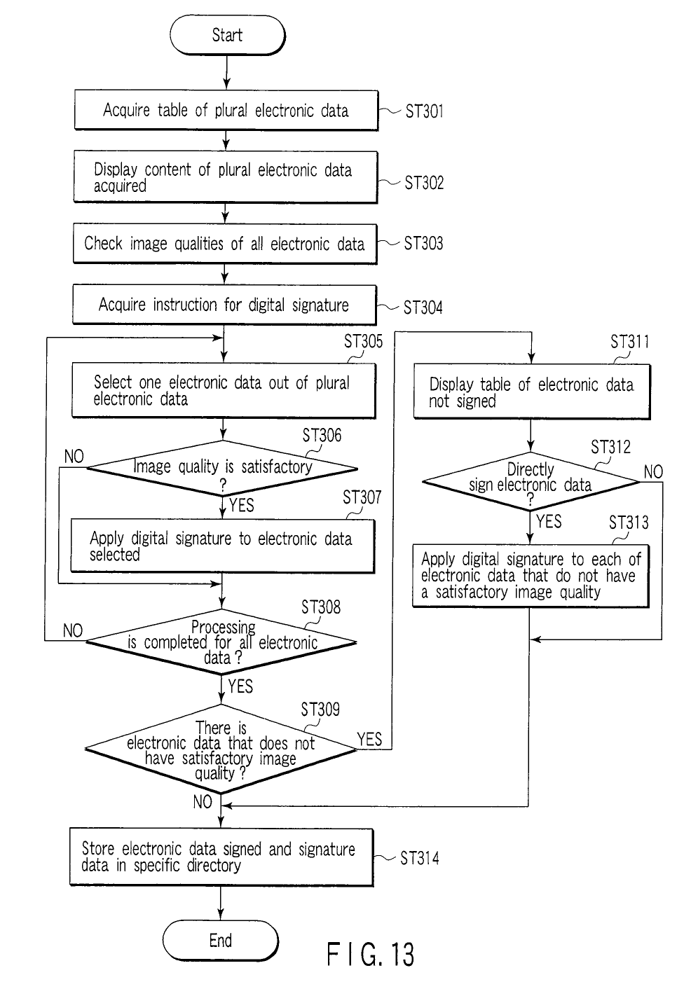

FIG. 13 is a flowchart showing a main part of processing at the time when the PC 3 applies processing to image data. Processing in steps ST301 and ST302 are the same as the processing in steps ST100 and ST102.

The PC 3 checks, using the image quality checking unit 43, an image quality of all the electronic data acquired (ST303). It is conceivable to check an image quality of electronic data using indexes such as resolution, gradation, brightness, contrast, color balance, chroma, hue, sharpness, density, inclination, and noise. In storing an image as electronic data, for example, the following criteria are set in the electronic document law in Japan. In the case of a color image, gradation equal to or higher than RGB 256 and resolution equal to or higher than 150 dpi (in the case of a tax document, equal to or higher than 200 dpi) are defined In the case of a monochrome image, monochrome two values and resolution equal to or higher than 150 dpi and monochrome halftone and resolution equal to or higher than 200 dpi are defined.

It is an object of this third embodiment to automatically detect an image quality that is generally considered to be hard to see. Therefore, since there is no criterion for an image quality hard to see, for example, a value of an image quality obtained by scanning a document having content hard to understand (totally white paper, black paper, etc.) is set as a criterion for the check. In other words, resolution equal to or higher than 200 dpi, gradation equal to or higher than 256 in the case of a color image or gradation of monochrome two values or monochrome halftone in the case of a monochrome image, an average brightness of the entire image not close to a value at the time when totally white paper or black paper is scanned, color balance not close to color balance at the time when totally white paper or black paper is scanned, and inclination not exceeding ten degrees, and noise not exceeding ten percent of the entire image are set as criteria. Therefore, the image quality checking unit 43 checks whether all the electronic data acquired satisfy these criteria. It is possible to judge this check by acquiring additional data added to electronic data.

When the PC 3 receives an input of the button 24 from the user and acquires an instruction for a digital signature (ST304), one list is selected out of the lists, or one electronic data is selected out of the plural electronic data acquired (ST305). It is judged whether the electronic data selected has a satisfactory image quality (ST306). The electronic data selected has a satisfactory image quality (YES in ST306), a digital signature is applied to the electronic data selected (ST307). If it is not confirmed that the electronic data selected is correct (NO in ST306), a digital signature is not applied to the electronic data. It is judged whether the processing has been completed for all the electronic data (ST308). When a judgment result is NO in step ST308, the PC 3 returns to step ST305 and the processing from step ST305 to step ST308 is repeated until the judgment result changes to YES in step ST308. Therefore, the digital signature is applied to electronic data having satisfactory image qualities, respectively.

When a judgment result is YES in step ST308, it is judged whether there is electronic data that does not have a satisfactory image quality (S309). The same judgment result is obtained even if it is judged whether there is electronic data to which the digital signature is not applied. When it is judged that there is electronic data that does not have a satisfactory image quality (YES in ST309), a table of electronic data not signed is displayed on the PC 3 (ST311).

FIG. 14 is a diagram showing a display screen 21b at the time when electronic data not signed as described above is displayed. On the display screen 21b, a table of electronic data (image files) that do not have a satisfactory image quality is displayed and reasons why the respective image data do not have a satisfactory image quality are also displayed. An indication for inquiring whether a signature is directly applied to these electronic data is also displayed. When the user signs the electronic data, the user inputs “Yes”. When the user does not sign the electronic data, the user inputs “No”.

When the table of electronic data not signed is displayed in step ST311, it is judged whether electronic data is directly signed (ST312). For example, if display shown on the display screen 21b in FIG. 14 is performed, it is judged whether “Yes” is inputted or “No” is inputted. When the electronic data is directly signed (YES in ST312), a digital signature is applied to the electronic data that does not have a satisfactory image quality. When there are plural electronic data that do not have a satisfactory image quality, the digital signature is applied to the respective image data (ST313). When the electronic data is not directly signed (NO in ST312), the processing in step ST313 is skipped. The processing from step ST305 to step ST313 is performed by the signing unit 44.

When there is no electronic data that does not have a satisfactory image quality (NO in ST309) when the digital signature is not applied to the electronic data that does not have a satisfactory image quality (ST313), or when the digital signature is not applied to the electronic data that does not have a satisfactory image quality (NO in ST312), the electronic data signed and signature data corresponding to the respective electronic data are stored in a specific directory of the file server 4 (ST314).

According to this third embodiment, when there is no electronic data that does not have a satisfactory image quality or when “directly sign the electronic data” (“Yes” of the display screen 21b) is selected even if there is electronic data that does not have a satisfactory image quality, the digital signature is applied to all the electronic data acquired. On the other hand, when there is electronic data that does not have a satisfactory image quality and “directly sign the electronic data” is not selected, the digital signature is applied only to the electronic data that has a satisfactory image quality.

Therefore, in collectively applying a digital signature to plural electronic data, when there is electronic data that has a low image quality, the electronic data is signed after asking the user whether the electronic data should be directly signed. This makes it possible to prevent the data with a low image quality from being directly signed and stored.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic data storing apparatus comprising:
a data acquiring unit configured to acquire plural electronic data;
a data displaying unit configured to display the plural electronic data acquired by the data acquiring unit;
a signing unit configured to apply, when an instruction for applying a digital signature to the plural electronic data displayed by the data displaying unit is acquired, the digital signature to each of the plural electronic data; and
a data transmitting unit configured to transmit the plural electronic data and signature data applied to each of the plural electronic data by the signing unit to a transmission destination set.

2. An electronic data storing apparatus according to claim 1, further comprising:
a content confirmation judging unit configured to judge whether content of each of the plural electronic data acquired by the data acquiring unit is correctly confirmed in accordance with a criterion set in advance for judging whether content of electronic data is correctly confirmed; and
a recording unit configured to record a result of judging, for each of the plural electronic data, whether content is correctly confirmed by the content confirmation judging unit, wherein
the signing unit applies, on the basis of the judgment result recorded by the recording unit, a digital signature only to electronic data, content of which is correctly confirmed, among the plural electronic data acquired.

3. An electronic data storing apparatus according to claim 2, further comprising a displaying unit configured to display electronic data, content of which is riot correctly confirmed, among the plural electronic data acquired.

4. An electronic data storing apparatus according to claim 2, wherein the criterion set in advance for judging whether content of the electronic data is correctly confirmed is whether the electronic data are displayed on the data displaying unit.

5. An electronic data storing apparatus according to claim 2, wherein the criterion set in advance for judging whether content of the electronic data is correctly confirmed is whether all pixels of electronic data are displayed in a section in which the electronic data is displayed.

6. An electronic data storing apparatus according to claim 2, wherein the criterion set in advance for judging whether content of the electronic data is correctly confirmed is whether a number of pixels set in advance among all pixels of electronic data is displayed.

7. An electronic data storing apparatus according to claim 2, wherein the criterion set in advance for judging whether content of the electronic data is correctly confirmed is whether, when electronic data is displayed by the data displaying unit, scroll bars displayed near the electronic data are entirely scrolled.

8. An electronic data storing apparatus according to claim 2, wherein the criterion set in advance for judging whether content of the electronic data is correctly confirmed is whether, when electronic data is displayed by the data displaying unit, the electronic data is displayed on the data displaying unit for a predetermined time or more.

9. An electronic data storing apparatus according to claim 2, wherein the criterion set in advance for judging whether content of the electronic data is correctly confirmed is whether, when electronic data is displayed by the data displaying unit, a specific portion set in advance of the electronic data is displayed on the data displaying unit.

10. An electronic data storing apparatus according to claim 2, wherein the criterion set in advance for judging whether content of the electronic data is correctly confirmed is whether, when electronic data is displayed by the data displaying unit, a confirmation button displayed near a specific portion set in advance of the electronic data is inputted.

11. An electronic data storing apparatus according to claim 10, wherein the confirmation button is displayed such that electronic data displayed behind the confirmation button is seen through.

12. An electronic data storing apparatus according to claim 1, further comprising an image quality checking unit configured to check whether an image quality of each of the electronic data acquired by the data acquiring unit is satisfactory in accordance with a criterion set in advance for judging whether an image quality of electronic data is satisfactory, wherein
the signing unit applies a digital signature only to electronic data that has a satisfactory image quality among the electronic data acquired.

13. An electronic data storing apparatus according to claim 12, wherein the signing unit inquires whether electronic data that does not have a satisfactory image quality as a result of the check by the image quality checking unit among the electronic data acquired should be signed and, when an instruction for applying a digital signature to the electronic data that does not have a satisfactory image quality is acquired, applies the electronic signature to the electronic data that does not have a satisfactory image quality.

14. An electronic data storing apparatus according to claim 12, wherein the criterion set in advance for judging whether an image quality of electronic data is satisfactory is a value of an image quality of electronic data at the time when a document, content of which is hardly understood, is scanned.

15. An electronic data storing apparatus comprising:
data acquiring means for acquiring plural electronic data;
data display means for displaying the plural electronic data acquired by the data acquiring means;
signing means for applying, when an instruction for applying a digital signature to the plural electronic data displayed by the data displaying unit is acquired, the digital signature to each of the plural electronic data; and
data transmitting means for transmitting the plural electronic data and signature data applied to each of the plural electronic data by the signing means to a transmission destination set.

16. An electronic data storing apparatus according to claim 15, further comprising:
content confirmation judging means for judging whether content of each of the plural electronic data acquired by the data acquiring means is correctly confirmed in accordance with a criterion set in advance for judging whether content of electronic data is correctly confirmed; and
recording means for recording a result of judging, for each of the plural electronic data, whether content is correctly confirmed by the content confirmation judging means, wherein
the signing means applies, on the basis of the judgment result recorded by the recording means, a digital signature only to electronic data, content of which is correctly confirmed, among the plural electronic data acquired.

17. An electronic data storing apparatus according to claim 15, further comprising image quality checking means for checking whether an image quality of each of the electronic data acquired by the data acquiring means is satisfactory in accordance with a criterion set in advance for judging whether an image quality of electronic data is satisfactory, wherein
the signing means applies a digital signature only to electronic data that has a satisfactory image quality among the electronic data acquired.

18. A method of storing electronic data of an electronic data storing apparatus comprising:
acquiring plural electronic data;
displaying plural electronic data acquired;
applying, when an instruction for applying a digital signature to plural electronic data displayed is acquired, the digital signature to each of the plural electronic data; and
transmitting the plural electronic data and signature data applied to each of the plural electronic data to a transmission destination set.

19. A method according to claim 18, further comprising:
judging whether content of each of the plural electronic data acquired is correctly confirmed in accordance with a criterion set in advance for judging whether content of electronic data is correctly confirmed; and
recording a result of judging, for each of the plural electronic data, whether content is correctly confirmed, wherein
in applying the signature, on the basis of the judgment result recorded, a digital signature is applied only to electronic data, content of which is correctly confirmed, among the plural electronic data acquired.

20. A method according to claim 18, further comprising checking whether an image quality of each of the electronic data acquired is satisfactory in accordance with a criterion set in advance for judging whether an image quality of electronic data is satisfactory, wherein
in applying the signature, a digital signature is applied only to electronic data that has a satisfactory image quality among the electronic data acquired.
